(19) United States
(12) Patent Application Publication
(10) Pub. No.: US 2012/0160759 A1
(43) Pub. Date: Jun. 28, 2012

(54) DUAL MEDIA FLUID FILTER

(76) Inventors: Ibrahim Khalil, Barrington, IL (US); John G. Eleftherakis, Cary, IL (US)

(21) Appl. No.: 13/325,932

(22) Filed: Dec. 14, 2011

Related U.S. Application Data
(63) Continuation-in-part of application No. 13/245,064, filed on Sep. 26, 2011.
Application No. 13/245,064 is a continuation of application No. 12/343,939, filed on Dec. 24, 2008, now Pat. No. 8,052,867.
(60) Provisional application No. 61/042,144, filed on Apr. 3, 2008.

(51) Int. Cl. B01D 29/27

(52) U.S. Cl. 210/335

(57) ABSTRACT

A fluid filter apparatus has an upper housing, a lower housing, a first media disposed between the upper and lower housing so that fluid passing from an inlet of the lower housing to an outlet of the upper housing must pass through to the first filter media, and a second filter media disposed adjacent the first filter media so that a portion of the fluid flowing from the inlet to the outlet must pass through both the first and second filter media.

### CROSS REFERENCE TO RELATED APPLICATIONS

This application is a continuation-in-part of U.S. patent application Ser. No. 13/245,064, filed on Sep. 26, 2011, currently pending, which is a continuation of U.S. patent application Ser. No. 12/343,939, filed on Dec. 24, 2008, now U.S. Pat. No. 8,052,867, which claimed priority to U.S. Provisional Patent Application Ser. No. 61/042,144, filed on Apr. 3, 2008. Priority is hereby claimed to all of the above mentioned applications. The entire contents of U.S. patent application Ser. No. 13/245,064, U.S. patent application Ser. No. 12/343,939, U.S. patent application Ser. No. 61/042,144 and U.S. Pat. No. 8,052,867 are all incorporated by reference herein in their entireties.

### BACKGROUND OF THE INVENTION

The invention generally pertains to fluid filters, and more particularly in some embodiments pertains to filters used to filter vehicular fluids such as filters for transmission fluids.

### SUMMARY OF THE INVENTION

In some aspects, the invention pertains to a fluid filter apparatus comprising an upper housing, a lower housing, a first filter media disposed between the upper and lower housing so that fluid passing from an inlet of the lower housing to an outlet of the upper housing passes through to the first filter media, and a second filter media disposed adjacent the first filter media so that a portion of the fluid flowing from the inlet to the outlet passes through both the first and second filter media.

In aspects of some embodiments, the upper and/or lower housings include a plurality of ribs, which space the first media away from an inner surface of the respective housing.

In some other aspects of some embodiments, the first media comprises a bag in the form of a folded over sheet, and the second media comprises a patch laid onto a portion of the first media.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation that may be apparent to those skilled in the art. Accordingly, the present invention resides in the novel methods, arrangements, combinations, and improvements herein shown and described in various exemplary embodiments.

### BRIEF DESCRIPTION OF THE DRAWINGS

FIG. 1 is an exploded view of a filter according to an embodiment of the invention, prior to assembly.

FIG. 2 is a cross-sectional view of the filter of FIG. 1, in a fully assembled condition.

FIG. 3 is a plan view of a first filter media prior to assembly in an unfolded condition including a second filter media.

### DETAILED DESCRIPTION OF THE INVENTION

In some aspects, the invention pertains to a filter comprising an upper housing, a lower housing, a first media mounted between the upper and lower housing so that fluid passing from an inlet of the lower housing to an outlet of the upper housing passes through to the first filter media and the second filter media disposed adjacent the first filter media so that a portion of the fluid flowing from the inlet to the outlet passes through both the first and second filter media.

In aspects of some embodiments, the lower housing includes a plurality of ribs on the upper and/or lower housing, which space the first media away from an inner surface of the respective housing.

In some other aspects of some embodiments, the first media comprises a bag in the form of a folded over sheet, and the second media comprises a patch laid onto a portion of the first media.

Some embodiments will now be described with reference to the drawing figures, in which like reference numerals refer to generally like parts throughout.

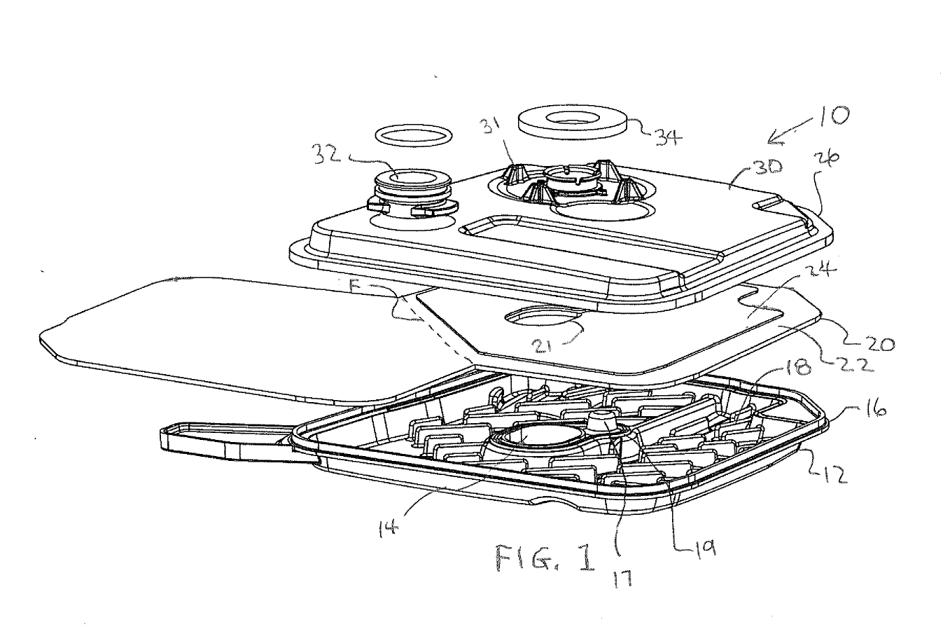

FIGS. 1-3 illustrate an example of an embodiment of a filter media. This example is adapted for use as an automotive transmission fluid filter. The filter 10 includes three main components.

First, the filter 10 includes a lower housing 12 which has a fluid inlet 14, a perimeter flange 16 and a plurality of internal ribs 18 which project upwardly from an inner bottom surface of the housing 12.

Second, the filter 10 includes a filter element 20 which includes a first filter media 22 and a second filter media 24 in the form of a patch. In some embodiments, the first filter media 22 may be relatively coarse and the second filter media 24 may be more relatively fine than the first filter media. Both filter media can in some embodiments be composed of a felt type material.

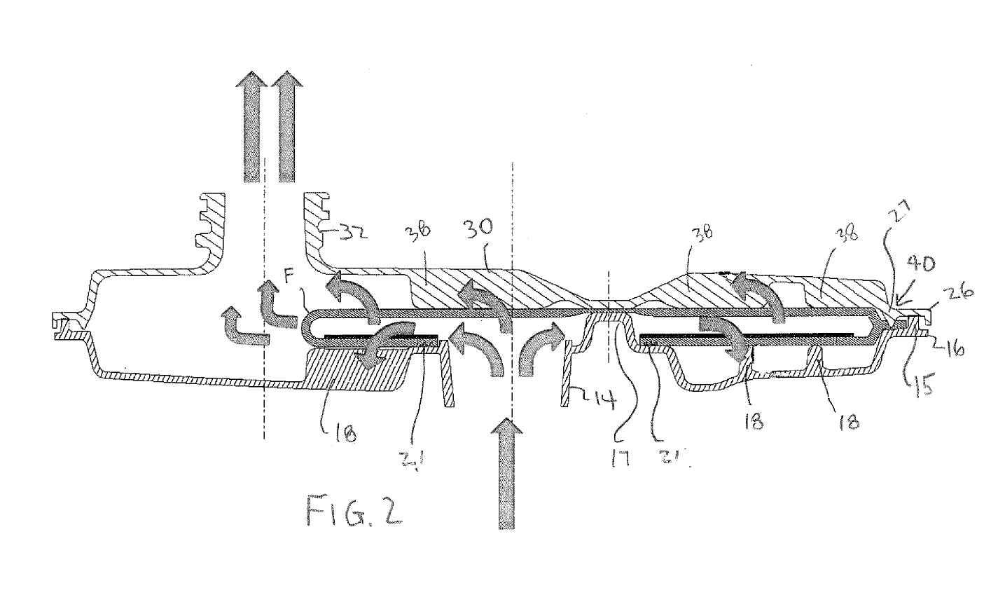

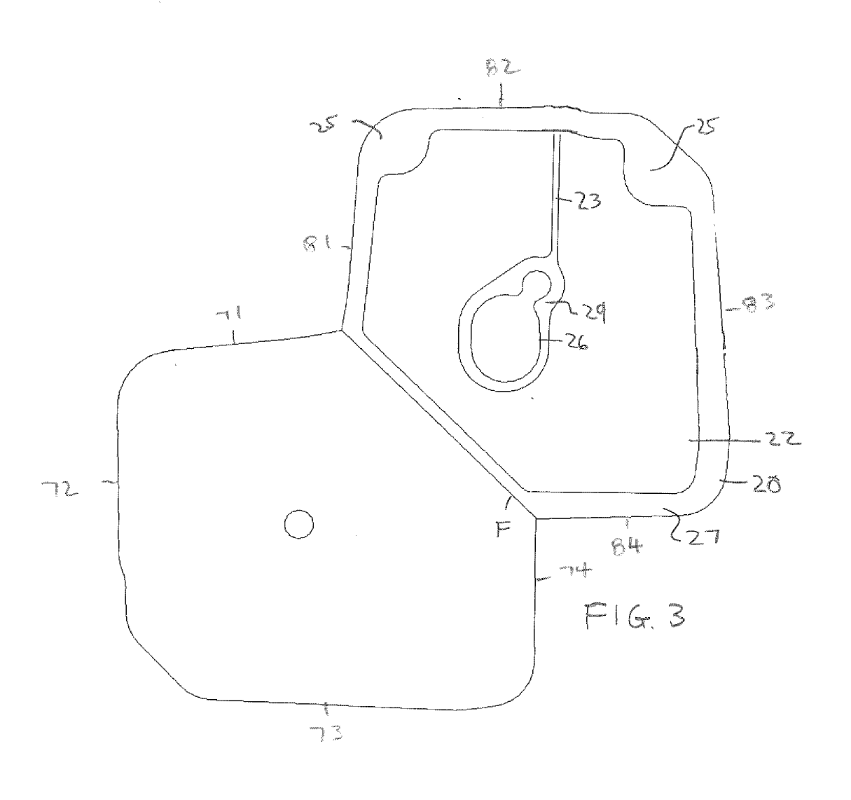

FIG. 1 shows the first filter media 22 in its configuration before assembly of the product, so that the first filter media is in the form of the flat sheet. As will be seen in FIG. 2, this filter media 22 is folded around a fold line F shown in FIG. 1 to form an enclosed bag in the assembled filter arrangement. Additionally, in this embodiment, the second filter media 24 is in the form of a patch that overlies a part of the first filter media 22. The first media 22 and the second media 24 have an aperture 21, or a hole, which permits fluid flow into the bag structure formed by the first media 22 and the second media 24 (as also depicted in FIGS. 2 and 3).

Third, the filter assembly 10 also includes an upper housing 30 which includes a fluid outlet 32. The upper housing 30 may also include a holder 31 for retention of a magnet 34 outside the housing, which may help in attracting any magnetic particles that were not captured by the filter media 20. The upper housing 30 also includes a perimeter flange 26. The upper housing 30 may also include internal ribs 36 (shown in FIG. 2).

FIG. 2 depicts fluid flow through the filter 10 from the inlet 14 to the outlet 32. This figure also shows the fold line F of the first filter media 22. At the peripheral edges of the first media 22 other than the fold line F, the outer edges of the first filter media 22 are crimped together by being trapped between the outer flanges 16 and 26 of the upper and lower housings, as shown in the region labeled 40. As depicted in the region labeled 40, the upper housing flange 26 may include a small projection 27 that helps crimp the outer edges of the first filter media 20 together against the flange 16 so that the first media 22 forms a bag.

The lower flange 16 has a projection 15 that contacts the flange 26 and provides a weld connection location to seal the upper housing 30 to the lower housing 20.

The lower housing 12 also has a pinch post 17 which projects upwardly towards the upper housing. A media mounting surface 19 is provided as a shape that surrounds the inlet 14 and the pinch post 17. The pinch post 17 is depicted projecting upwardly through the aperture 26 so that it pinches the first media 22 at a pinch point where it pushes against the inside surface of the upper housing 30. The surface of the media mounting surface 19 may be ribbed or roughened in order to accept the attachment of the media by adhesives or welding. The adhesive or welding attachment occurs at the media attachment portion 19. FIG. 2 also shows that the outer portion of the first media 22 in the region immediately surrounding the aperture 21 is attached by gluing or welding to the lower housing in a region surrounding the media mounting surface 19.

The heavy arrows in FIG. 2 depict fluid flow from the inlet 14 to the outlet 32. It will be seen that some fluid passes only through the first media 22 and other fluid passes through both the first media 22 and the second media 24. The positive flow pressure provided at the inlet will cause the bag shape of the media element 20 to tend to inflate or expand outwardly. This pressure thus causes the media element 20 formed by media 22 and media 24 to expand outwardly and towards the insides of the upper and lower housings 12 and 30 respectively. The ribs 18 in the lower housing 12, (which are shown to the right side of FIG. 2) help prevent the outer surface of the first media 22 from coming into a completely flush contact with the inside of the lower housing, which could inhibit fluid flow. The upper housing 30 may also have ribs 38 disposed in the same arrangement as the ribs 18 or disposed in a complimentary or different arrangement as the ribs 18. FIG. 2 also depicts ribs 38 which are oriented in complete cross-section in this view, and which also permit flow around those ribs 38. FIG. 2 shows a section line taken through such ribs so the flow indicated by the heavy arrows and the upper portion of FIG. 2 is occurring on one side of these ribs.

FIG. 3 is a plan view of the filter element 20 comprising media 22 and 24 prior to installation between the housings. The second media 24 may be sized to cover a majority of one folded portion of the first media 22. However, in this embodiment the media 22 on the folded portion is not entirely covered by the patch 24. It will be appreciated that the aperture 21 in this embodiment is surrounded by a region 29 which is a media mounting region in the first media 22 that corresponds in shape outline generally to the media mounting region 19. Also, in this embodiment, a peripheral region 27 of the first media 22 is not covered by the second media 24. This peripheral region 27 may generally correspond to the region that is crimped between the first housing 12 and the second housing 30. Also, the region of the first media 22 adjacent the fold line F may be partially not covered by the second media 24, in order to allow for a smooth folding. Finally, additional corner regions 25 and/or an intermediate region 23 may be left uncovered by the second media 24 in regions where there is a pinch point between the lower housing 16 and the upper housing 30.

FIG. 3 also shows the first media 22 when flat has two regions separated by the fold line F. The first region has four substantially straight sides 71, 72, 73, 74 and the second region has four substantially straight sides 81, 82, 83, 84, with the fold being at an angle thereto.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A fluid filter apparatus comprising:
an upper housing;
a lower housing;
a first filter media bag disposed between the upper housing and the lower housing so that all fluid passing from an inlet of the lower housing to an outlet of the upper housing must pass through to the first filter media; and
a second filter media disposed adjacent the first filter media so that a portion of the fluid flowing from the inlet to the outlet must pass through both the first and second filter media.

2. A fluid filter apparatus according to claim 1, wherein the first filter media forms a bag.

3. A fluid filter apparatus according to claim 2, wherein the second filter media is disposed inside the bag.

4. A fluid filter apparatus according to claim 3, wherein the upper housing has internal ribs to space the first filter media bag away from an inner surface of the upper housing and the lower housing has internal ribs to space the first filter media bag away from an internal surface of the lower housing.
